(19) United States
(12) Patent Application Publication
(10) Pub. No.: US 2023/0324930 A1
(43) Pub. Date: Oct. 12, 2023

(54) METHOD OF CONTROLLING SAFETY OF UNMANNED AERIAL VEHICLE AND SYSTEM FOR PERFORMING THE SAME

(71) Applicant: ELECTRONICS AND TELECOMMUNICATIONS RESEARCH INSTITUTE, Daejeon (KR)

(72) Inventors: Moon Sung PARK, Daejeon (KR); Bong Soo KIM, Daejeon (KR); Dong-Gil NA, Daejeon (KR); Yeong-Woong YU, Daejeon (KR); Hoon JUNG, Daejeon (KR)

(21) Appl. No.: 18/182,574

(22) Filed: Mar. 13, 2023

(30) Foreign Application Priority Data
Apr. 6, 2022 (KR) 10-2022-0042635

(51) Int. Cl. G05D 1/10; B64D 45/00; G08G 5/00; G05D 1/00

(52) U.S. Cl. CPC G05D 1/106; B64D 45/00; B64U 10/00; G08G 5/0069; G05D 1/0011; G08G 5/0034

(57) ABSTRACT

Provided are a method of controlling safety of an Unmanned Aerial Vehicle (UAV) and a system for performing the method. The method of controlling the safety includes identifying a failure of a UAV for each of a plurality of mission performance operations of the UAV, based on status data of the UAV received in real time from the UAV and past flight performance data of a case where the UAV normally performs a mission and controlling safety of the UAV based on the failure for each of the plurality of mission performance operations and a risk level of the failure. The status data may include component operation status data of the UAV, power status data of the UAV, and communication connection status data of the UAV.

### CROSS-REFERENCE TO RELATED APPLICATION

This application claims the benefit of Korean Patent Application No. 10-2022-0042635 filed on Apr. 6, 2022, in the Korean Intellectual Property Office, the entire disclosure of which is incorporated herein by reference for all purposes.

### BACKGROUND

### 1. Field of the Invention

One or more embodiments relate to a method of controlling safety of an unmanned aerial vehicle and a system for performing the method.

### 2. Description of the Related Art

A drone is a generic term for an unmanned aerial vehicle (UAV), which is an object flying, based on aerodynamic force, autonomously or by a remote control without a pilot to perform a mission. Technical development enables the UAV to be applied to various fields, including the military field and the civilian field. In order to ensure the safety of the UAV, there may be commonly used technology, such as technology for generating a travel path for effective performance of a mission and technology for comparing power consumption to battery capacity required for a mission to identify whether to perform a mission.

The above description has been possessed or acquired by the inventor(s) in the course of conceiving the present disclosure and is not necessarily an art publicly known before the present application is filed.

### SUMMARY

There may be a difficulty in commercializing an unmanned aerial vehicle (UAV) since various conditions, such as operation status data, power supply, and flight environment of the UAV, may need to be checked in order to perform a mission (e.g., delivery of goods) by using the UAV. For the safety of a mission (e.g., delivery of goods) performed by a UAV, there may a demand for technology for controlling the UAV against a possible failure during delivery performed by the UAV (e.g., an error in operation status data of a UAV before or during a mission, power shortage before or during the mission, a communication failure during a mission, an altitude deviation failure, a position deviation failure, lack of time, a failure of operating a device in a UAV, and the like).

Embodiments provide technology for controlling a UAV according to the type of a failure after identifying the failure of the UAV before or during a mission performed by the UAV.

However, the technical aspects are not limited to the aforementioned aspects, and other technical aspects may be present.

According to an aspect, there is provided a method of controlling safety, the method including identifying a failure of an Unmanned Aerial Vehicle (UAV) for each of a plurality of mission performance operations of the UAV, based on status data of the UAV received in real time from the UAV and past flight performance data of a case where the UAV normally performs a mission, and controlling safety of the UAV based on the failure for each of the plurality of mission performance operations and a risk level of the failure. The status data may include component operation status data of the UAV, power status data of the UAV, and communication connection status data of the UAV.

The plurality of mission performance operations may include a mission preparation operation, a take-off operation, a travel operation, and a delivery operation.

The identifying may include identifying the failure in the mission preparation operation and generating a mission of the UAV based on a result of the identifying in the mission preparation operation.

The identifying may include identifying a failure based on the power status data. The controlling of the safety may include, in the mission preparation operation, controlling the safety, so that performance of a mission is not initiated in response to the failure based on the power status data and, in the travel operation, sequentially performing temporary mission suspension control, mission reduction control, and emergency landing control in response to the failure based on the power status data. The mission reduction control may include control for generating a reduced mission by reducing a travel distance of the UAV based on a path of a mission and a value of a possible flight distance according to the power status data of the UAV.

The identifying may include identifying a failure according to the communication connection status data. The controlling of the safety may include, in the travel operation, continuously making a request for communication reconnection to the UAV configured to autonomously control the safety according to a result of identifying the failure according to the component operation status data.

The UAV configured to autonomously control the safety may, when there is no failure according to the component operation status data, continue to perform a mission even when there is the failure according to the communication connection status data and, when there is the failure according to the component operation status data, autonomously control the safety according to a risk level of the failure according to the component operation status data.

The identifying may include identifying a failure due to deviation of a position of the UAV and deviation of an altitude of the UAV. The controlling of the safety may include, in the take-off operation, sequentially performing temporary mission suspension control, position return control, mission reduction control, and emergency landing control in response to the failure due to the deviation of the position of the UAV and the deviation of the altitude of the UAV and, in the travel operation, when a risk level of the failure due to the deviation of the position of the UAV and the deviation of the altitude of the UAV is warning, performing the mission reduction control and, when the risk level of the failure due to the deviation of the position of the UAV and the deviation of the altitude of the UAV is emergency, sequentially performing the temporary mission suspension control, the position return control, the mission reduction control, and the emergency landing control. The mission reduction control may include control for generating a reduced mission by reducing a travel distance of the UAV based on a path of a mission and a value of a possible flight distance according to the power status data of the UAV, and the position return control may include control for moving the UAV to a next waypoint among a plurality of waypoints in the path of the mission when the UAV deviates from the position and control for moving the UAV up and down by as much as a deviated altitude when the UAV deviates from the altitude.

The identifying of the failure due to the deviation of the position of the UAV and the deviation of the altitude of the UAV may include determining, to be any one of the warning and the emergency, a risk level of the failure due to the deviation of the position of the UAV and the deviation of the altitude of the UAV, according to whether the UAV deviates from an angle, a distance, and the altitude, by comparing the path of the mission and a current position of the UAV included in the status data.

The identifying may include identifying a failure according to a final rejection of Unmanned Aircraft System (UAS) traffic management (UTM) or geofence information. The controlling of the safety may include, in the mission preparation operation, controlling the safety, so that performance of a mission is not initiated in response to the final rejection and performing mission modification control in response to the failure according to the geofence information and, in the travel operation, performing temporary mission suspension control in response to the failure according to the geofence information and the mission modification control based on the geofence information. The mission modification control may include control for reaching a target point in a path of the mission by deviating from an area corresponding to the geofence information by a shortest distance, along an outline of the area.

The identifying may include identifying a failure due to a failure of a mission. The controlling of the safety may include, in the delivery operation, sequentially performing temporary mission suspension control, mission reduction control, and emergency landing control when the mission is a drop-off delivery and sequentially performing the mission reduction control and mission termination when the mission is a landing delivery.

The method may further include, in the mission preparation operation, comparing a sum of a departure preparation time, a take-off time, and an arrival interval maintenance time of the UAV to a time interval between a time when another UAV besides the UAV releases occupancy of a departure point included in the mission and a time when the UAV initiates the occupancy of the departure point and determining a departure time of the UAV based on whether occupancy times between the UAV and the other UAV overlap.

A communication channel with the UAV may include a normal port configured to transmit and receive a mission and status data and an urgent port configured to receive, from the UAV, a result in which the UAV autonomously identifies a failure and transmit, to the UAV, a control signal corresponding to the controlling of the safety.

According to another aspect, there is provided a ground control system including a memory including instructions and a processor electrically connected to the memory and configured to execute the instructions. When the instructions are executed by the processor, the processor may be configured to identify a failure of an Unmanned Aerial Vehicle (UAV) for each of a plurality of mission performance operations of the UAV, based on status data of the UAV received in real time from the UAV and past flight performance data of normal mission performance of the UAV and control safety of the UAV based on the failure for each of the plurality of mission performance operations and a risk level of the failure. The status data may include component operation status data of the UAV, power status data of the UAV, and communication connection status data of the UAV.

The plurality of mission performance operations may include a mission preparation operation, a take-off operation, a travel operation, and a delivery operation.

The processor may be configured to identify the failure in the mission preparation operation and generate a mission of the UAV based on a result of the identifying in the mission preparation operation.

The processor may be configured to identify a failure based on the power status data, in the mission preparation operation, control the safety, so that performance of a mission is not initiated in response to the failure based on the power status data, and in the travel operation, sequentially perform temporary mission suspension control, mission reduction control, and emergency landing control in response to the failure based on the power status data. The mission reduction control may include control for generating a reduced mission by reducing a travel distance of the UAV based on a path of a mission and a value of a possible flight distance according to the power status data of the UAV.

The processor may be configured to identify a failure according to the communication connection status data and, in the travel operation, continuously make a request for communication reconnection to the UAV configured to autonomously control the safety according to a result of identifying the failure according to the component operation status data.

The UAV configured to autonomously control the safety may, when there is no failure according to the component operation status data, continue to perform a mission even when there is the failure according to the communication connection status data and, when there is the failure according to the component operation status data, autonomously control the safety according to a risk level of the failure according to the component operation status data.

The processor may be configured to identify a failure due to deviation of a position of the UAV and deviation of an altitude of the UAV, in the take-off operation, sequentially perform temporary mission suspension control, position return control, mission reduction control, and emergency landing control in response to the failure due to the deviation of the position of the UAV and the deviation of the altitude of the UAV and, in the travel operation, when a risk level of the failure due to the deviation of the position of the UAV and the deviation of the altitude of the UAV is warning, perform the mission reduction control and, when the risk level of the failure due to the deviation of the position of the UAV and the deviation of the altitude of the UAV is emergency, sequentially perform the temporary mission suspension control, the position return control, the mission reduction control, and the emergency landing control. The mission reduction control may include control for generating a reduced mission by reducing a travel distance of the UAV based on a path of a mission and a value of a possible flight distance according to the power status data of the UAV. The position return control may include control for moving the UAV to a next waypoint among a plurality of waypoints in the path of the mission when the UAV deviates from the position and control for moving the UAV up and down by as much as a deviated altitude when the UAV deviates from the altitude. According to another aspect, there is provided a system including an unmanned aerial vehicle (UAV) and a ground control system configured to be communicatively connected to the UAV and an Unmanned Aircraft System (UAS) traffic management (UTM) system. The ground control system may include a memory including instructions and a processor electrically connected to the memory and configured to execute the instructions. When the instructions are executed by the processor, the processor is configured to identify a failure of the UAV for each of a plurality of mission performance operations of the UAV, based on status data of the UAV received in real time from the UAV and past flight performance data of normal mission performance of the UAV and control safety of the UAV based on the failure for each of the plurality of mission performance operations and a risk level of the failure. The status data may include component operation status data of the UAV, power status data of the UAV, and communication connection status data of the UAV.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1A is a diagram schematically illustrating a control system according to various embodiments;

FIG. 1B is a diagram illustrating a ground control system according to various embodiments;

FIG. 2 is a table illustrating an operation of generating a safety control procedure in which an identification module identifies a failure in a control system according to a mission performance operation and responds to the failure;

FIG. 3A is a diagram illustrating an operation of identifying a failure according to power status data of an unmanned aerial vehicle (UAV), according to various embodiments;

FIG. 3B is a diagram illustrating an operation of identifying a failure according to data comparison on component operation state of the UAV in a delivery preparation operation, according to various embodiments;

FIG. 4 is a diagram illustrating an operation in which a generation module determines a departure time and an occupancy time of a mission, according to various embodiments;

FIG. 5A is a diagram illustrating an operation in which an identification module identifies a failure of a UAV on a mission due to position deviation and altitude deviation in a horizontal section, according to various embodiments;

FIG. 5B is a diagram illustrating an operation in which the identification module according to various embodiments identifies a failure of the UAV on a mission due to altitude deviation in an inclination ascending section;

FIG. 5C is a diagram illustrating an operation in which the identification module according to various embodiments identifies a failure of the UAV on a mission due to altitude deviation in an inclination descending section;

FIG. 6A is a diagram illustrating an operation in which an identification module according to various embodiments identifies a failure due to a decrease in altitude, based on power status data of a UAV flying between two consecutive waypoints;

FIG. 6B is a diagram illustrating an operation in which the identification module according to various embodiments identifies whether the UAV may perform a mission during the failure due to the decrease in altitude, based on the power status data of the UAV;

FIG. 7 is a flowchart illustrating an operation in which an aircraft management module autonomously identifies a communication failure of a UAV on a mission;

FIG. 8 is a diagram illustrating an operation in which an identification module according to various embodiments identifies a failure due to an occupancy time;

FIG. 9 is a flowchart illustrating an operation in which a ground control system according to various embodiments performs safety control of a UAV according to a mission performance operation when the ground control system identifies geofence information from an Unmanned Aircraft System (UAS) Traffic Management (UTM) system;

FIG. 10 is a flowchart illustrating an operation in which a ground control system according to various embodiments determines whether to continuously perform a mission according to a result of identifying a failure due to a delivery failure of a UAV arriving at any one of a plurality of target points included in the mission; and

FIG. 11 is another example of a ground control system according to various embodiments.

### DETAILED DESCRIPTION

The following structural or functional descriptions of examples are merely intended for the purpose of describing the examples and the examples may be implemented in various forms. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the embodiments with reference to the accompanying drawings, like reference numerals refer to like constituent elements and a repeated description related thereto will be omitted.

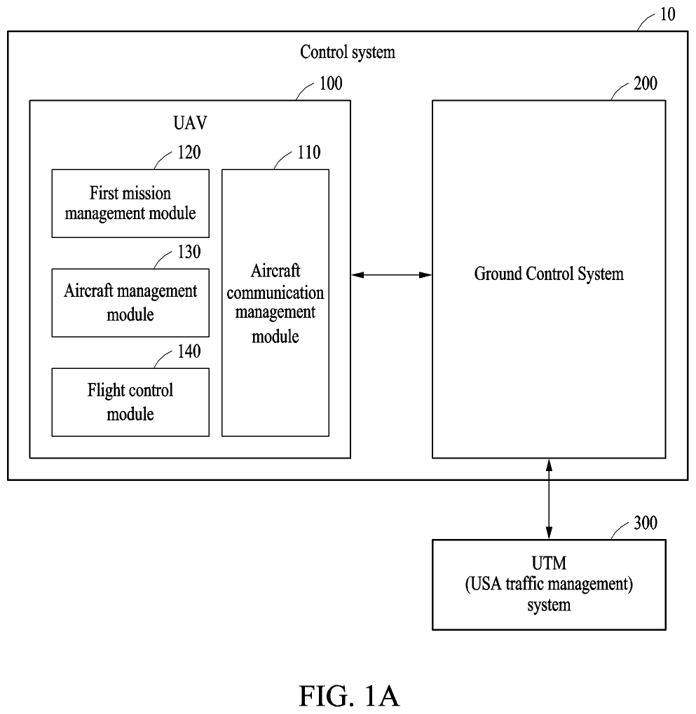

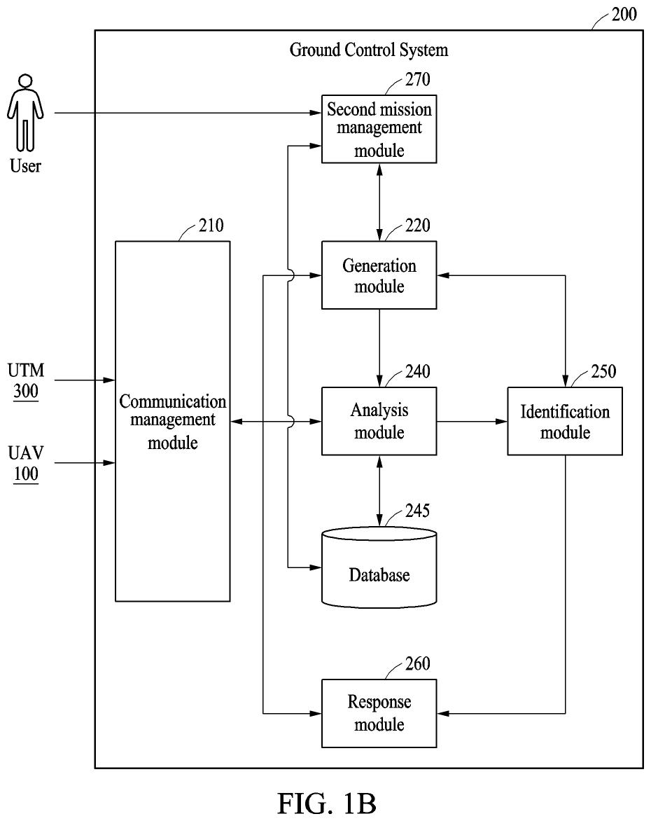

FIG. 1A is a diagram illustrating a control system according to various embodiments.

Referring to FIG. 1A, a control system 10 may include an unmanned aerial vehicle (UAV) 100 and a ground control system 200. The control system 10 may utilize each component (e.g., the UAV 100 and the ground control system 200) to control the UAV 100 according to a mission performance operation, so that the UAV 100 may safely perform a mission (e.g., a product delivery mission). The control system 10 may communicatively connect to an Unmanned Aircraft System (UAS) traffic management (UTM) system 300.

According to various embodiments, the UAV 100 may include a first mission management module 120, an aircraft management module 130, and a flight control module 140. The UAV 100 may utilize each component (e.g., an aircraft communication management module 110, the first mission management module 120, the aircraft management module 130, and the flight control module 140) to safely perform a mission received from the ground control system 200.

The UAV 100 may provide operation condition data and registration details according to the mission device type of the UAV 100 (e.g., a model name of the UAV 100) to the ground control system 200 when the UAV 100 communicatively connects to the ground control system 200.

According to various embodiments, the aircraft communication management module 110 may manage communication connection to the ground control system 200. The first mission management module 120 may register a mission (e.g., a product delivery mission) to the flight control module 140. The aircraft management module 130 may acquire data about the existence of an obstacle in a take-off section and the status data of the UAV 100 and may transmit, to the ground control system 200, a failure autonomously identified by the aircraft management module 130 based on the existence of the obstacle in the take-off section and the state data of the UAV 100, through the aircraft communication management module 110. The flight control module 140 may control the flight of the UAV 100 based on a control signal generated by the ground control system 200.

According to various embodiments, the ground control system 200 may receive status data (e.g., status data about components, power, and communication connection) of the UAV 100 from the UAV 100. The ground control system 200 may identify a failure of the UAV 100 based on the status data and flight performance data stored in a database and may generate a modification mission for coping with the failure of the UAV 100 according to a result of identifying the failure or determine whether the mission may be continuously performed.

According to various embodiments, the UTM system 300 may transmit a final approval for the mission to the ground control system 200, based on the mission and environment data of a path related to the mission (e.g., weather condition data, geofence, an overlapping path between UAVs, an overlapping occupancy time in a delivery section, and an overlapping altitude) received from the ground control system 200.

A communication channel between the aircraft communication management module 110 of the UAV 100 and a communication management module (e.g., a communication management module 210 of FIG. 1B) of the ground control system 200 may be divided into a normal port and an urgent port. The normal port may be used to transmit a delivery mission to the UAV 100, to receive a delivery mission from the UAV 100, and to transmit operation state values of the UAV 100 to the ground control system 200. When the UAV 100 autonomously identifies a failure, the urgent port may be used to transfer a result of identifying the failure to the ground control system 200. When the failure is identified in the ground control system 200, the urgent port may be used to transmit a control signal for controlling the UAV 100.

FIG. 1B is a diagram illustrating a ground control system according to various embodiments.

Referring to FIG. 1B, the ground control system 200 may include a communication management module 210, a generation module 220, an analysis module 240, a database 245, an identification module 250, a response module 260, and a second mission management module 270. The ground control system 200 may use each component (e.g., the communication management module 210, the generation module 220, the analysis module 240, the database 245, the identification module 250, the response module 260, and the second mission management module 270) to control the UAV 100 according to a mission performance operation, so that the UAV 100 may safely perform a mission (e.g., a product delivery mission).

According to various embodiments, the communication management module 210 may perform communication connection to the UAV 100 to identify the mission device type (e.g., a model name of the UAV 100) of the UAV 100 and may manage data about a communication connection state to control the UAV 100 according to a mission performance operation, based on the ID of the UAV 100. The communication management module 210 may receive, from the UAV 100, a result of identifying status data of the UAV 100, based on the status data of the UAV 100 (e.g., status data about component operation, power, and communication connection).

According to various embodiments, the generation module 220 may receive a mission plan (e.g., a delivery mission plan) from the second mission management module 270. The mission plan may be generated by the second mission management module 270, based on a user's input. The generation module 220 may receive information about a failure of the UAV 100 from the identification module 250. The generation module 220 may generate a mission (e.g., a product delivery mission) when a failure (e.g., a communication failure, a component failure, and the like) of the UAV 100 does not exist according to information about the failure of the UAV 100 and may not generate a mission when there is a failure of the UAV 100.

According to various embodiments, the analysis module 240 may receive a result of identifying the status data of the UAV 100 from the communication management module 210 before the mission of the UAV 100 starts, based on the status data (e.g., status data about component operation, power, communication, and travel) of the UAV 100. The analysis module 240 may compare the status data of the UAV 100 to flight performance data of the UAV 100. For example, the ground control system 200 may compare component status data of the UAV 100 (e.g., sensor values, positions, altitudes, posture values, and the like) to the flight performance data when the UAV 100 normally operated in the past. The flight performance data may be provided from the database 245 and include an achievement rate against a set value of travel conditions, the average travel speed of the UAV 100 (km/h), a flight distance (m), and power consumption (v/m and v/sec), and the like. The flight performance data may be generated by the analysis module 240 and be stored in the database 245 by mapping to a mission device type (e.g., a model name of the UAV 100), travel conditions (e.g., take-off, vertical ascent, horizontal travel, up/down travel, vertical descent, landing, hovering, and stand-by time before delivery) and operation conditions (the weight of delivered products and power status data of the UAV 100).

According to various embodiments, the database 245 may store the flight performance data related to past flights of the UAV 100 and the position value of a safe landing point for an emergency landing other than a departure point and a target point within a mission performance area. The second mission management module 270 may generate a mission plan using information about the safe landing point.

According to various embodiments, the identification module 250 may identify that a failure exists when a result (e.g., deviation) of comparing the status data of the UAV 100 to the flight performance data of the UAV 100 exceeds a predetermined value.

According to various embodiments, the generation module 220 may generate a mission based on the mission plan received from the second mission management module 270 when it is identified that there is no failure.

According to various embodiments, the analysis module 240 may predict whether the UAV 100 successfully completes the mission based on flight status data and the flight performance data, in which the UAV 100 successfully completed a delivery in the past. For example, the analysis module 240 may predict the amount of power consumption corresponding to the mission, based on a power value in the flight status data and the flight performance data received from the UAV 100.

The identification module 250 may determine whether a mission (e.g., a product delivery mission) may be performed before the UAV 100 initiates the mission. For example, the identification module 250 may determine whether the mission may be performed, based on predicted data (e.g., the amount of power consumption) of the UAV 100 and the mission generated by the generation module 220.

According to various embodiments, when the identification module 250 determines that the UAV 100 may perform the mission, the generation module 220 may determine the departure time of the UAV 100 to prevent, from overlapping, occupation times at each of a starting point and one or more target points included in the mission (e.g., a delivery mission). The generation module 220 may transmit, to the UTM system 300, the mission (e.g., product delivery mission), for which the departure time is determined, through the communication management module 210, and may request a final approval for the mission, based on the environmental data of a path (e.g., weather condition data, geofence, overlapping paths between other UAVs, overlapping occupancy times in a delivery section, overlapping travel altitudes, and the like).

According to various embodiments, when the communication management module 210 receives geofence information or a final rejection from the UTM system 300 before the UAV 100 initiates the mission, the communication management module 210 may transmit the geofence information or the final rejection to the identification module 250. The identification module 250 may determine whether there is a path related to performing the mission in the geofence area, based on the geofence information. When the path related to performing the mission invades the geofence area, the identification module 250 may transmit, to the generation module 220, a mission modification message to request that the path be modified to bypass the geofence area. The identification module 250 may identify a failure according to the final rejection and cause the response module 260 to output a message “inability to initiate the mission”.

According to various embodiments, when the communication management module 210 receives the final approval from the UTM system 300, the communication management module 210 may transmit a request that the mission be performed, to the UAV 100. When the communication management module 210 receives, from the UAV 100, a rejection response according to the request that the mission be performed, the communication management module 210 may transmit the rejection response and a delivery mission to the second mission management module 270 through the generation module 220. When the UAV 100 transmits the rejection response due to the overlapping of mission performance times (e.g., a product delivery time) of the UAV 100, the second mission management module 270 may store the mission corresponding to the rejection response in the database 245 and then re-generate a mission to prevent the overlapping of mission performance times.

According to various embodiments, the communication management module 210 may transmit the mission to the UAV 100, so that the UAV 100 may register the mission to the flight control module 140 through the first mission management module 120 and then may perform the mission.

According to various embodiments, when the UAV 100 autonomously identifies a communication failure (e.g., communication disconnection between the UAV 100 and the communication management module 210), the UAV 100 may request the communication management module 210 to reconnect communication at regular time intervals and may autonomously generate a flight control signal based on the component status data of the UAV 100. The UAV 100 may continue to perform the mission when there is no failure in the components of the UAV 100 according to the component status data, during the communication failure of the UAV 100. When there is a failure in the components during the disconnected communication, the UAV 100 may determine to generate of a flight control signal for moving the UAV 100 to a closer waypoint among a next waypoint and a waypoint before the communication failure occurs.

According to various embodiments, when the UAV 100 on a mission communicatively connects to the communication management module 210, the UAV 100 may receive existing flight performance data mapping to the mission device type (e.g., the model name of the UAV 100) of the UAV 100, the travel conditions, and the operation conditions, through the communication management module 210. The ground control system 200 may generate modified flight performance data by combining the existing flight performance data with current flight data.

According to various embodiments, the analysis module 240 may receive status data (e.g., component operation status data and power status data) of the UAV 100 from the UAV 100 through the communication management module 210 before the UAV 100 initiates the mission. The analysis module 240 may analyze (e.g., compare) the status data, the flight performance data, and the mission of the UAV 100.

According to various embodiments, the identification module 250 may identify a failure for each of mission performance operations (e.g., a take-off operation, a travel operation (delivery and return), and a delivery operation) of the UAV 100 on the mission, based on a result of the analysis. The identification module 250 may generate a safety control procedure for the UAV 100 in response to a result of the identifying the failure and transmit the safety control procedure to the response module 260. The response module 260 may generate a control signal corresponding to the safety control procedure to control the UAV 100 to safely perform or complete the mission despite the failure.

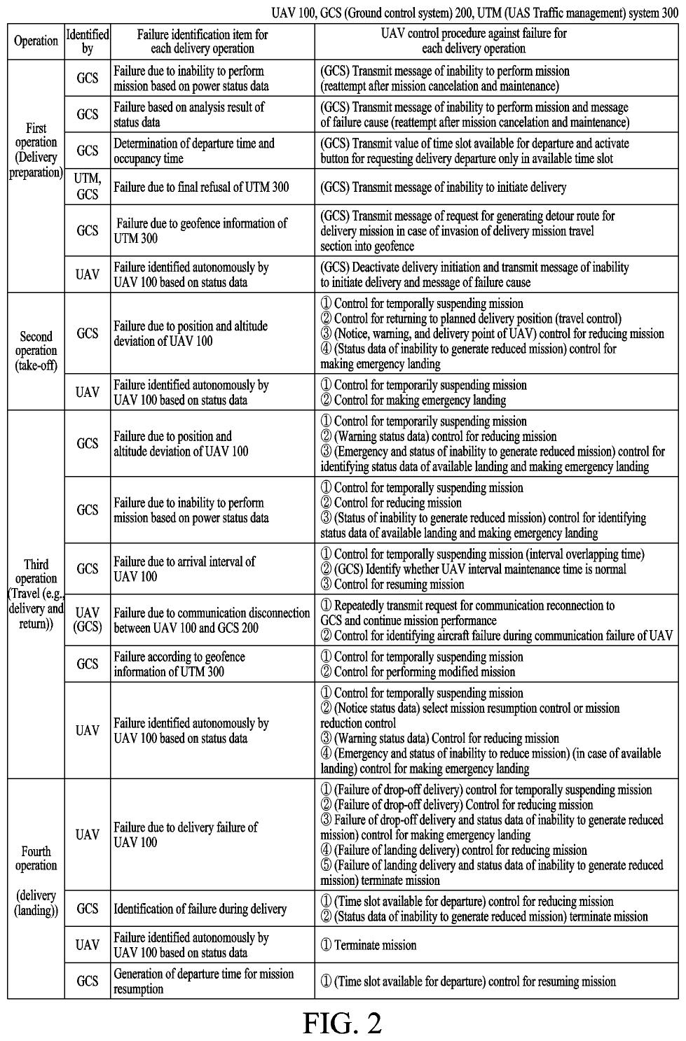

FIG. 2 is a table illustrating an operation of generating a safety control procedure in which an identification module identifies a failure in a control system according to a mission performance operation and responds to the failure.

Referring to FIG. 2, according to various embodiments, an identification module 250 may identify a failure in a control system according to a mission performance operation (e.g., a first operation (e.g., a delivery preparation operation), a second operation (e.g., a take-off operation), a third operation (a travel operation), and a fourth operation (a landing operation)). A failure in the control system may include one or more of: a failure due to inability to generate a time available for departure of a UAV 100; a failure due to inability to perform a mission based on power status data; a failure based on a result of analyzing status data of the UAV 100; a failure autonomously identified by the UAV 100 based on the status data; a failure according to a final rejection of the UTM system 300 or geofence information; a failure according to a result of analyzing the position deviation and altitude deviation of the UAV 100; a failure due to a decrease in altitude based on the power status data of the UAV 100; a failure due to the arrival interval of the UAV 100; a failure due to delivery failure of the UAV 100; a failure due to disconnected communication between the UAV 100 and a ground control system 200; and a failure due to inability of the UAV 100 to land. The identification module 250 may generate a safety control procedure in response to the identified failure and transmit the safety control procedure to at least one of a generation module 220 and a response module 260, in order for the generation module 220 to generate a reduced mission, a modified mission, or a position return mission or in order for the response module 260 to generate a control signal corresponding to the safety control procedure.

The identification module 250 may identify, in the first operation (e.g., the delivery preparation operation), a failure due to inability to perform a mission based on the power status data of the UAV 100, a failure based on a result of analyzing the status data, and a failure autonomously identified by the UAV 100 based on the status data and may generate a safety control procedure responding thereto. The safety control procedure may include a procedure for generating an error message (e.g., “inability to initiate a mission”) and a procedure for generating a message requesting that the status data of the UAV 100 be inspected.

According to various embodiments, the identification module 250 may identify a failure according to the geofence information or the final rejection received from the UTM system 300 in the first operation (e.g., the delivery preparation operation) and may generate a safety control procedure responding thereto. The safety control procedure corresponding to the failure according to the geofence information may include a procedure for generating a mission modification message requesting the generation module 220 to modify a mission plan, so that a path bypasses the geofence area. The safety control procedure in response to the failure according to the final rejection may include a procedure for generating an error message (e.g. “inability to initiate a mission”).

According to various embodiments, the identification module 250 may identify a failure due to position deviation and altitude deviation of the UAV 100 in the second operation (e.g., the take-off operation) and may generate a safety control procedure in response to the failure. The safety control procedure may include a procedure for sequentially performing temporary mission suspension control, position return control, mission reduction control, and emergency landing control.

According to various embodiments, the identification module 250 may identify a failure autonomously identified by the UAV 100 based on component operation status data in the second operation (e.g., the take-off operation) and generate a safety control procedure in response to the failure. The safety control procedure may include a procedure for sequentially performing the temporary mission suspension control and the emergency landing control.

According to various embodiments, the identification module 250 may identify a failure due to the position deviation and altitude deviation of the UAV 100 in the third operation (e.g., the travel operation) and generate a safety control procedure in response to the failure. The safety control procedure may include a procedure for performing the temporary mission suspension control, the position return control, the mission reduction control, and the emergency landing control according to whether the UAV 100 may land. The mission reduction control may be performed when the risk level of a failure is warning and the emergency landing control may be performed when the risk level of a failure is emergency.

According to various embodiments, the identification module 250 may identify a failure due to a decrease in altitude based on the power status data of the UAV 100 in the third operation (e.g., the travel operation) and generate a safety control procedure in response to the failure. The safety control procedure may include a procedure for performing the position return control; another position return control according to a result of predicting the position of an altitude deviation when the altitude of the UAV 100 continues to decrease despite the performance of the position return control; the mission reduction control; and an emergency landing request when the UAV 100 is in a registered departure point, a target point, or a safe landing point, or the emergency landing control by checking the availability of landing based on a result obtained by the sensor of the UAV 100 and identifying a possible landing area and the gradient value of a landing point through the management module 130.

According to various embodiments, the identification module 250 may identify a failure due to inability to perform a mission based on the power status data of the UAV 100 in the third operation (e.g., the travel operation) and may generate a safety control procedure in response to the failure. The safety control procedure may include a procedure for performing the temporary mission suspension control, the mission reduction control, and the emergency landing control.

According to various embodiments, the identification module 250 may identify a failure according to the arrival interval of the UAV 100 in the third operation (e.g., the travel operation) and generate a safety control procedure in response to the failure. The safety control procedure may include a procedure for sequentially performing the temporary mission suspension control and mission resumption control according to the interval time of the UAV 100.

According to various embodiments, the identification module 250 may identify a failure due to communication disconnection between the UAV 100 and the ground control system 200 in the third operation (e.g., the travel operation) and generate a safety control procedure in response to the failure. The safety control procedure may include a procedure for continuously performing the mission while the UAV 100 is re-requesting the ground control system 200 to connect communication at regular intervals. During the failure due to the communication disconnection, the UAV 100 may request the aircraft management module 130 to continuously perform the mission or generate a procedure for changing the path and perform the procedure, according to a result of identifying the component operation status data of the UAV 100.

According to various embodiments, the identification module 250 may identify a failure according to the geofence information of the UTM system 300 in the third operation (e.g., the travel operation) and generate a safety control procedure in response to the failure. The safety control procedure may include a procedure for performing the temporary mission suspension control and the mission modification control according to a result of a mission generated based on the geofence information. According to various embodiments, the identification module 250 may identify a failure autonomously identified by the UAV 100 based on the component operation status data in the third operation (e.g., the travel operation) and generate a safety control procedure in response to the failure. The safety control procedure may include a procedure for sequentially performing the temporary mission suspension control; any one of the mission resumption control and the mission reduction control; the mission reduction control; and the emergency landing control based on a result of identifying a possible landing position. Any one of the mission resumption control and the mission reduction control may be performed when the risk level of the failure is notice, the mission reduction control may be performed when the risk level of failure is warning or emergency, and the emergency landing may be performed based on the result of identifying the possible landing position.

According to various embodiments, the identification module 250 may identify a failure due to delivery failure of the UAV 100 in the fourth operation (e.g., the delivery (landing) operation) and generate a safety control procedure in response to the failure. The safety control procedure may include a procedure for sequentially performing the temporary mission suspension control, the mission reduction control, and the emergency landing control in the case of a drop-off delivery and may sequentially performing the mission reduction control and mission termination in the case of a landing delivery.

According to various embodiments, the identification module 250 may identify a failure autonomously identified by the UAV 100 based on status data in the fourth operation (e.g., the delivery (landing) operation) and may generate a safety control procedure for terminating the mission in response to the failure.

For a completed landing delivery, in which there has been a failure of the risk level of notice or warning and then the mission has been resumed in a section from a departure to a completed delivery (e.g., a take-off operation, a travel operation, a delivery (landing) operation), the identification module 250 may generate a procedure for terminating the mission in response thereto.

According to various embodiments, the temporary mission suspension control and the mission resumption control may include control in which the response module 260 may generate a control signal for requesting the temporary mission suspension control and the mission resumption control of the UAV 100, respectively, and a control signal for transmitting the generated control signals to the UAV 100. The position return control may include control in which the response module 260 may generate a control signal for requesting a position return, transmit the generated control signal to the UAV 100, and check path return status data according the control signal of the UAV 100.

According to various embodiments, the emergency landing control may include control in which, when the response module 260 identifies a possible position for an emergency landing, the response module 260 may generate a control signal for requesting the emergency landing, transmit the generated control signal to the UAV 100, and terminate the mission of the UAV 100 after checking the landing state of the UAV 100 according to the control signal.

According to various embodiments, the mission reduction control and the mission modification control may include control for transmitting a reduced mission and a modified mission generated by the generation module 220 according to the control signals of the response module 260, respectively, and control for terminating the mission of the UAV 100 after checking the reduced mission and the modified mission performed by the UAV 100 and the landing of the UAV 100.

According to various embodiments, mission data to request the position return control may include waypoint data to move the UAV 100 to a next waypoint in the case of position deviation and may include control data to move the UAV 100 up and down by as much as a deviated altitude value in the case of altitude deviation.

According to various embodiments, mission data to request the mission reduction control used for mission reduction may include mission reduction control data to be transmitted to the UAV 100. In the mission reduction control data, a flight distance value according to remaining power and a travel distance from the UAV 100 to a registered starting point, a target point, a return point, and a safe landing point may be calculated and a travelable point according to the flight distance value and a provided position may be selected.

According to various embodiments, the mission data to request a mission modification control used to control mission modification may include a shortest path around the outline of a geofence area and a waypoint of a path that moves away from the geofence area and moves to a target point.

According to various embodiments, the control for identifying the component operation status data of the UAV 100 during a failure due to communication disconnection may include control in which the UAV 100 may generate a control signal according to the risk level of a failure, using an aircraft management module (e.g., the aircraft management module 130 of FIG. 1A) when it is determined by using a flight control module (e.g., the flight control module 140 of FIG. 1A) that there is the failure according to the component operation status data of the UAV 100 during communication disconnection between the UAV 100 and the ground control system 200. The aircraft management module 130 may generate a control signal for moving the UAV 100 to a closer waypoint between a waypoint before the communication failure and a next waypoint when the risk level of the failure is warning and may generate a control signal corresponding to the emergency landing control when the risk level of the failure is emergency. The flight control module 140 may control the UAV 100 according to the control signal.

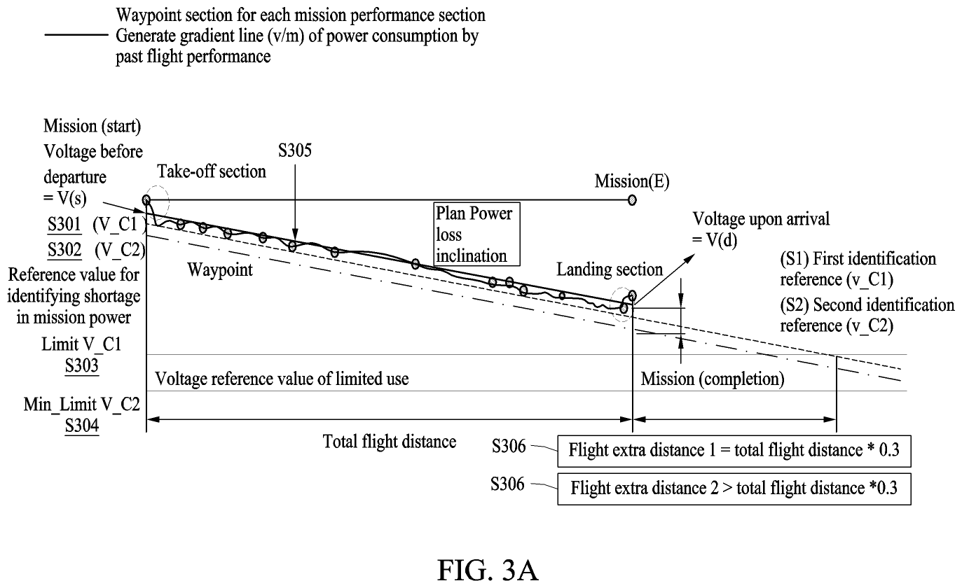

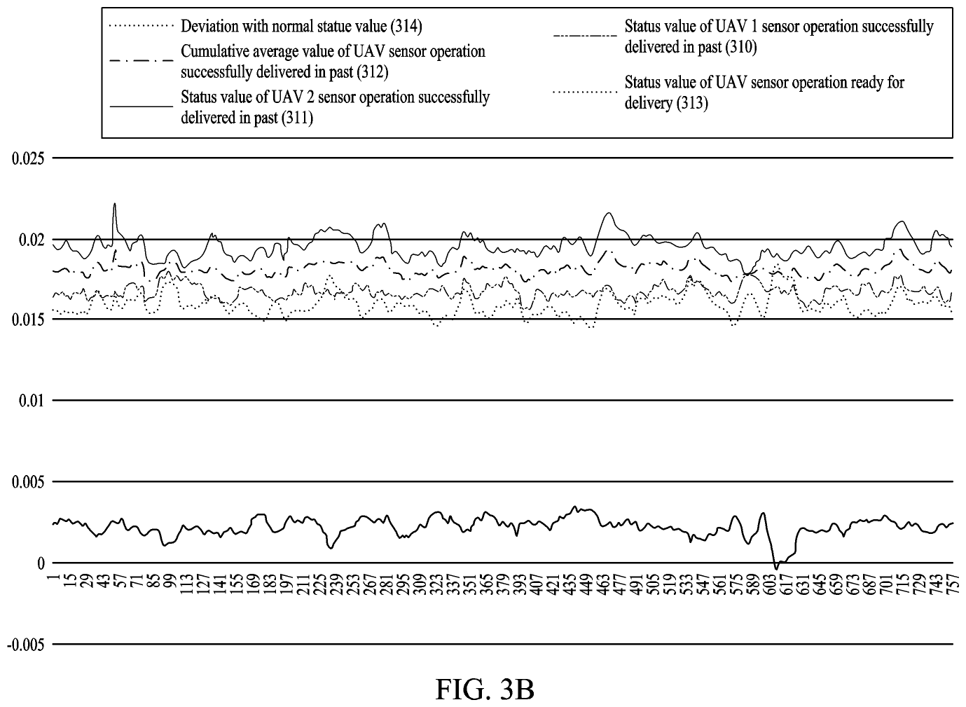

FIG. 3A is a diagram illustrating an operation of identifying a failure according to power status data of a UAV 100 according to various embodiments.

Referring to FIG. 3A, according to various embodiments, an identification module (e.g., the identification module 250 of FIG. 1B) may calculate a first predicted amount of power consumption required for the performance of a mission of a UAV (e.g., the UAV 100 of FIG. 1B), based on flight performance data and the mission generated by a generation module (e.g., the generation module 220 of FIG. 1B). The identification module 250 may subtract a difference between the first predicted amount of power consumption and a second predicted amount of power consumption according to the travel of an extra distance from the current amount of power of the UAV 100 and may then divide the remaining value after the subtraction by the total travel distance of the UAV 100 according to the mission to thus calculate a power consumption gradient. The second predicted amount of power consumption may be set to be a minimum amount of power against a failure during the performance of the mission. The identification module 250 may calculate a predicted amount of power consumption corresponding to a remaining flight distance, based on the power consumption gradient and a flight distance and remaining flight according to the current position of the UAV 100. The identification module 250 may identify a failure according to power status data by comparing the predicted amount of power consumption corresponding to the remaining flight distance to a reference voltage of power shortage. The reference voltage of power shortage may vary depending on a mission.

According to various embodiments, the identification module 250 may receive, from an analysis module 240, a result of comparing the power status data of the UAV 100 to the flight performance data in which the UAV 100 was in a normal operation in the past.

FIG. 3B is a diagram illustrating an operation of identifying a failure according to data comparison on component operation state of the UAV 100 in a delivery preparation operation, according to various embodiments.

According to various embodiments, the identification module 250 may identify, as a failure, a large deviation between component operation status data and flight performance data in which the UAV 100 was in a normal operation in the past, according to a result of the comparison. When the failure occurs, a safety control procedure against the failure may include a procedure for generating an error message (e.g., “a failure identification item and inability to initiate a mission”).

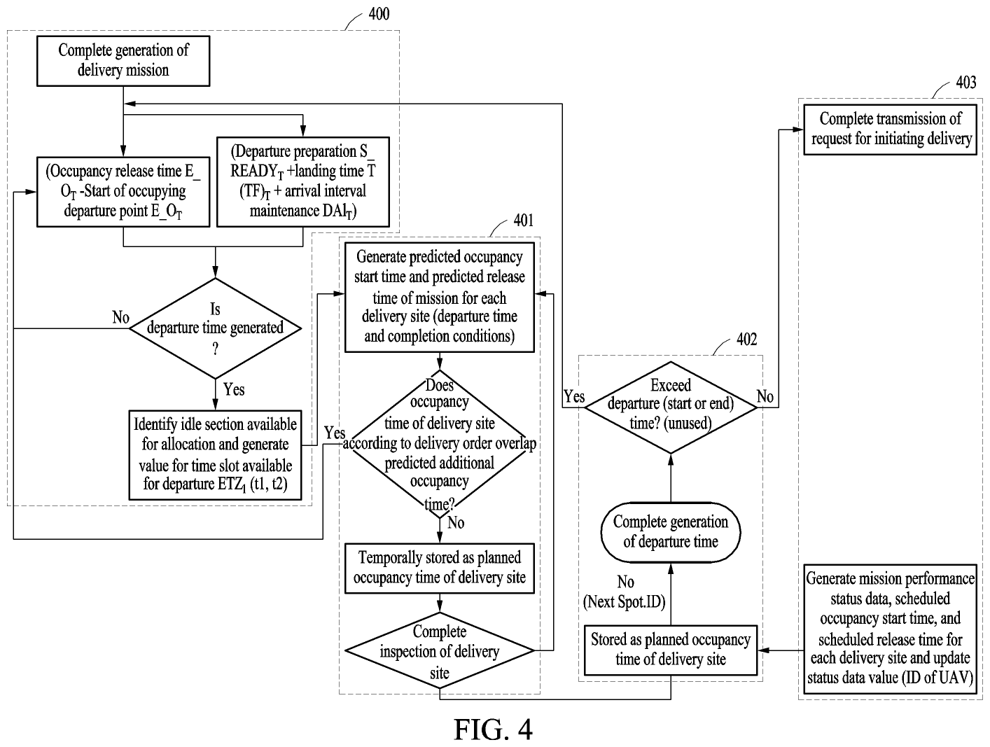

FIG. 4 is a diagram illustrating an operation in which a generation module 220 determines a departure time and an occupancy time of a mission, according to various embodiments.

Operations 400 to 403 may be operations in which the generation module 220 according to various embodiments determines a departure time and an occupancy time of the UAV 100, so that occupancy times at a departure point and one or more target points (e.g., a plurality of product delivery sites) included in a mission (e.g., a product delivery mission) do not overlap each other.

In operation 400, when the identification module 250 identifies that the UAV 100 may perform a mission according to power status data, the generation module 220 may determine the departure time of the UAV 100 by comparing a time interval between a time when a UAV other than the UAV 100 releases the occupancy of a departure point and a time when (e.g., a current time) the UAV 100 starts occupying the departure point, to a sum of a departure preparation time, a take-off time, and an arrival interval maintenance time of the UAV 100. When the time interval is less than the sum, the generation module 220 may not determine the departure time and may compare the time interval to the sum again based on the current time. When the time interval is greater than the sum, the generation module 220 may determine the departure time.

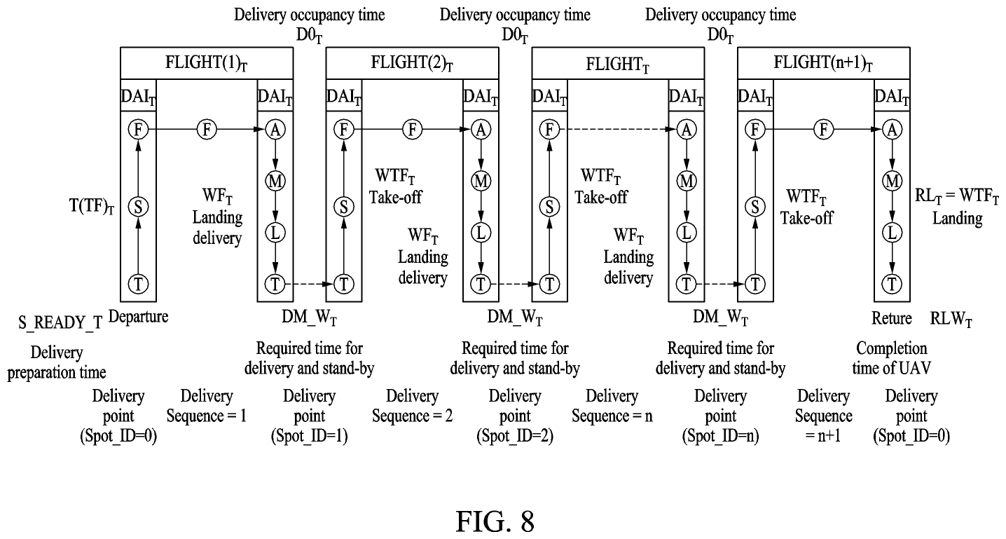

In operation 401, after the departure time is determined, the generation module 220 may determine a time when a UAV other than the UAV 100 releases the occupancy of one or more target points and a time when the UAV 100 occupies the one or more target points based on a predicted time, a predicted occupancy release time, a mission performance sequence (e.g., a delivery sequence) of the UAV 100 at the one or more target points (e.g., a plurality of goods delivery sites). For example, the generation module 220 may determine when a UAV other than the UAV 100 occupies the one or more target points and when the UAV 100 occupies the one or more target points. When the identification module 250 may not determine the occupancy time due to overlapping of the occupancy times in the operation described with reference to FIG. 8 below, the identification module 250 may identify a failure due to the overlapping.

In operation 402, upon determination of the departure time and the occupancy time, the generation module 220 may store the departure time and the occupancy time in a database. The generation module 220 may re-perform operations 400 and 401 when the UAV 100 does not initiate the performance of a mission before the determined departure time due to a series of subsequent processes. For example, when a ground control system (e.g., the ground control system 200 of FIG. 1A) does not receive geofence information and a final approval from a UTM system (e.g., the UTM system 300 of FIG. 1A), the generation module 220 may re-perform operations 400 and 401.

In operation 403, the generation module 220 may store time data at the departure point and the one or more target points of the UAV 100 in a database when the UAV 100 starts performing the mission before or at the determined departure time.

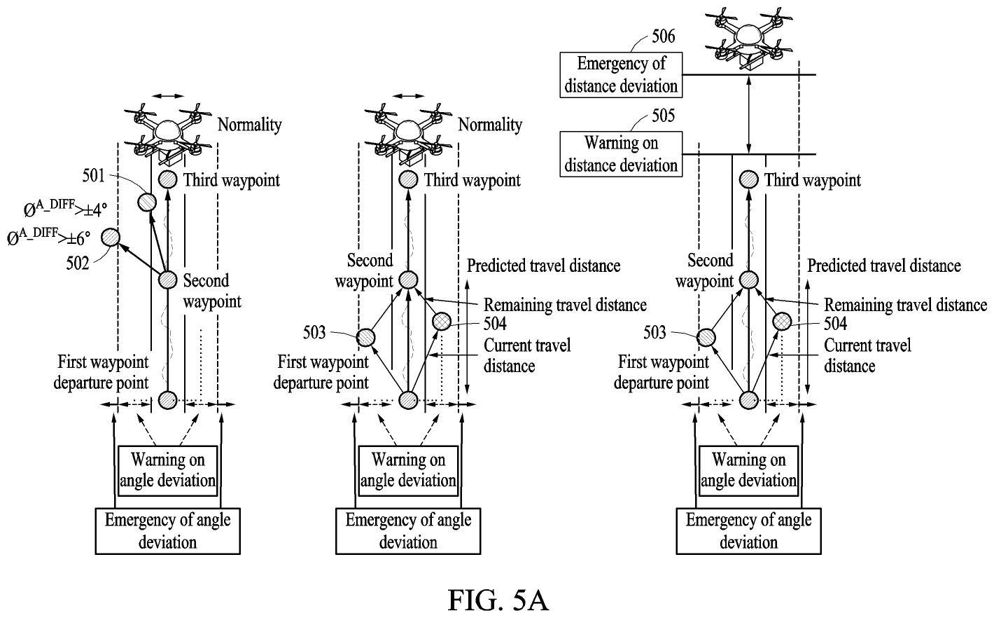

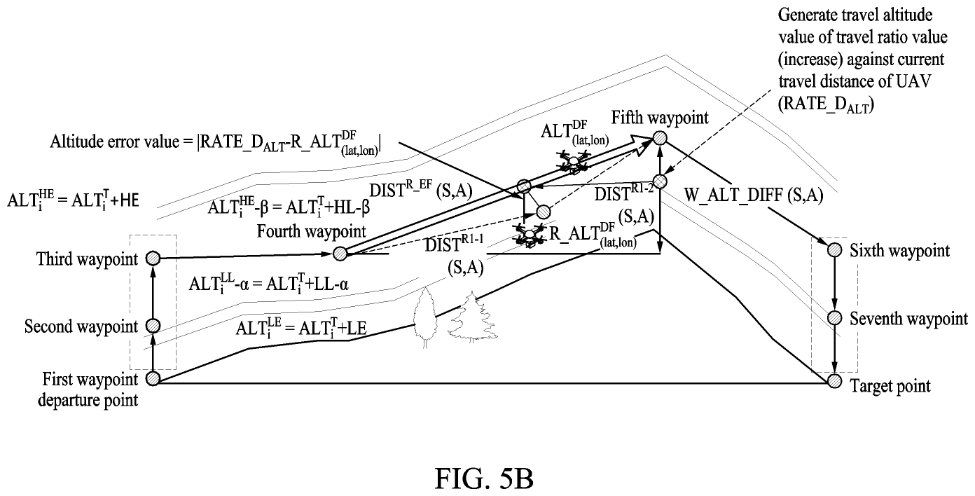

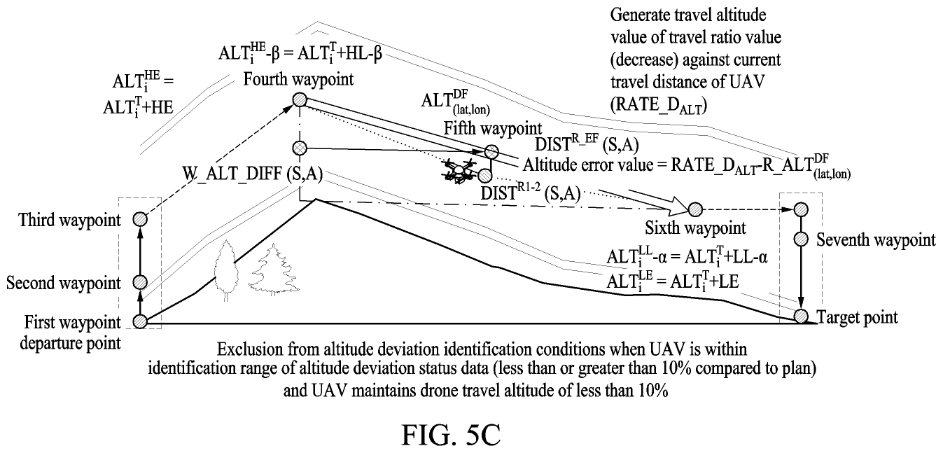

FIG. 5A is a diagram illustrating an operation in which an identification module 250 identifies a failure due to position deviation and altitude deviation of a UAV 100 on a mission, according to various embodiments.

Referring to FIG. 5A, according to various embodiments, an identification module (e.g., the identification module 250 of FIG. 1B) may receive, in real time, the current position of the UAV 100 according to status data of an analysis module 240 and a result of analyzing a path of a UAV 100 included in a mission and may identify a failure related to an altitude and a position within the path of the UAV 100 based on the analyzed result. Whether the UAV 100 deviates from the position may include whether the UAV 100 deviates from an angle and a distance. The path of the UAV 100 may include one or more waypoints and one or more target points. Among the one or more waypoints, a first waypoint may be a departure point of the path.

According to various embodiments, the identification module 250 may identify whether the UAV 100 deviates based a difference between an angle (e.g., a predicted travel angle) formed by two consecutive waypoints (e.g., the first waypoint and a second waypoint or the second waypoint and a third waypoint) of the UAV 100 based on the coordinate system of a UTM system 300; and an angle (e.g., an actual travel angle) formed between the current position of the UAV 100 and a previous waypoint among the two consecutive waypoints. The difference between the predicted travel angle and the actual travel angle may be defined as in [Equation 1]. When the difference between the predicted travel angle and the actual travel angle exceeds a warning identification reference value (e.g., 4 degrees), the identification module 250 may identify the risk level of failure of the angle deviation as a level 501 of warning. When the difference between the predicted travel angle and the actual travel angle is greater than an emergency identification reference value (e.g., 6 degrees), the identification module 250 may identify the risk level of failure of the angle deviation as emergency.

Ø^{A_DIFF}=|Ø^{FSA_R}−Ø^{FSA_P}| [Equation 1]

Here, Ø^{FSA_P} may denote a predicted travel angle and may be defined by [Equation 2], and Ø^{FSA_R} may denote an actual travel angle and may be defined by [Equation 3].

$${ϕ}^{FSA \_ P} = sin ( \frac{( {x}_{2} - {x}_{1} )}{\sqrt{{( {x}_{2} - {x}_{1} )}^{2} \_ {( {y}_{2} - {y}_{1} )}^{2}}} ) * ( \frac{180}{π} ) \qquad [ Equation 2 ]$$

Here, x₁ and y₁ may denote the x-coordinate and y-coordinate of the preceding waypoint among two consecutive waypoints, and x₂ and y₂ may denote the x-coordinate and y-coordinate of the later waypoint among the two consecutive waypoints.

$${ϕ}^{FSA \_ R} = sin ( \frac{( {x}_{c} - {x}_{1} )}{\sqrt{{( {x}_{c} - {x}_{1} )}^{2} + {( {y}_{c} - {y}_{1} )}^{2}}} ) * ( \frac{180}{π} ) \qquad [ Equation 3 ]$$

Here, x₁ and y₁ may denote the x-coordinate and y-coordinate of the preceding waypoint among two consecutive waypoints, and xc and Ye may be the x-coordinate and y-coordinate of the current position of the UAV 100.

According to various embodiments, the identification module 250 may identify whether the UAV 100 deviates from a distance, based on a distance between two consecutive waypoints (e.g., a predicted travel distance) and the actual travel distance of the UAV 100. The actual travel distance of the UAV 100 may be the sum of: a distance (e.g., a current travel distance) between the preceding waypoint among the two consecutive waypoints of the UAV 100 and the current position of the UAV 100; and a distance (e.g., a remaining travel distance) between the later waypoint among two consecutive waypoints and the current position of the UAV 100. For example, when an actual travel distance is greater than 1.1 times a predicted travel distance, the identification module 250 may identify the risk level of the failure of distance deviation as warning. When an actual travel distance is greater than 1.15 times a predicted travel distance, the identification module 250 may identify the risk level of the failure of distance deviation as emergency. When the identification module 250 identifies a failure in any one of the angle deviation and the distance deviation, the identification module 250 may identify that the UAV 100 has a failure of the position deviation.

According to various embodiments, when the UAV 100 flies higher than an altitude at the later waypoint among two consecutive waypoints or flies beyond a safe flight altitude range, the identification module 250 may identify the risk level of the failure of altitude deviation as warning or emergency. The identification module 250 may identify a failure of the altitude deviation based on a difference between the current altitude of the UAV 100 and the predicted altitude of the UAV 100 in a horizontal section. The identification module 250 may identify a failure due to the altitude deviation in an ascending section and a descending section according to the operation described below with reference to FIGS. 5B and 5C.

According to various embodiments, when all the risk levels of failures due to angle deviation, position deviation, and altitude deviation are identified as waring, the identification module 250 may identify the risk levels of the failures due to the position deviation and the altitude deviation as warning. When one or more risk levels of the failures due to angle deviation, position deviation, and altitude deviation are identified as emergency, the identification module 250 may identify the risk levels of the failures due to the position deviation and the altitude deviation as emergency.

FIG. 5B is a diagram illustrating an operation in which the identification module 250 according to various embodiments identifies a failure of the UAV 100 on a mission due to altitude deviation in an inclination ascending section.

Referring to FIG. 5B, according to various embodiments, an identification module (e.g., the identification module 250 of FIG. 1B) may identify a failure due to altitude deviation based on an actual travel distance and a predicted travel distance in an ascending section and based on an actual altitude and a predicted altitude in the current position of the UAV 100. According to various embodiments, the identification module 250 may calculate ratios (e.g., predicted ratios) of a predicted travel distance and a predicted altitude between two waypoints and may calculate ratios (e.g., actual ratios) of an actual distance traveled from a preceding waypoint among the two waypoints based on the current position of the UAV 100 and an actual altitude between the preceding waypoint among the two waypoints and the current position of the UAV 100. The identification module 250 may identify the risk level of the altitude deviation of the UAV 100 in stages (e.g., warning and emergency) based on the actual rates and the predicted rates.

Referring to FIG. 5C, according to various embodiments, an identification module (e.g., the identification module 250 of FIG. 1B) may identify a failure of the UAV 100 due to the altitude deviation based on an actual travel distance and a predicted travel distance in a descending section and an actual altitude and a predicted altitude at the current position of the UAV 100.

According to various embodiments, the identification module 250 may calculate ratios (e.g., predicted ratios) of a predicted travel distance between two waypoints and a predicted altitude between the two waypoints and may calculate ratios (e.g., actual ratios) of an actual distance traveled from a preceding waypoint among the two waypoints based on the current position of the UAV 100 and an actual altitude between the preceding waypoint among the two waypoints and the current position of the UAV 100. The identification module 250 may identify the risk level of the altitude deviation of the UAV 100 in stages (e.g., warning and emergency) based on the actual rates and the predicted rates.

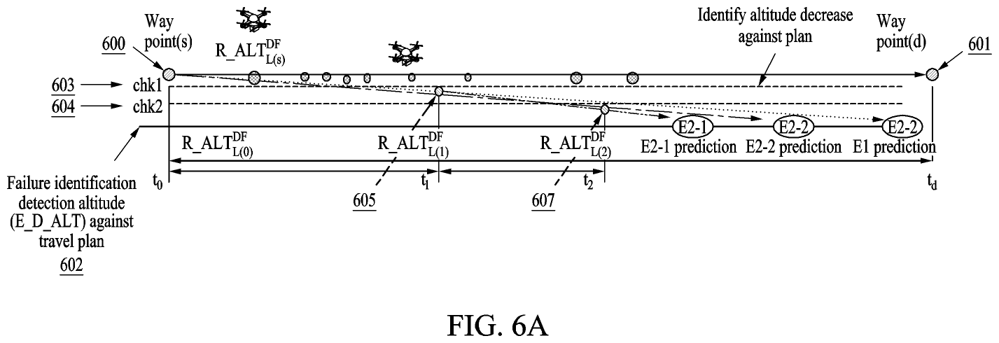

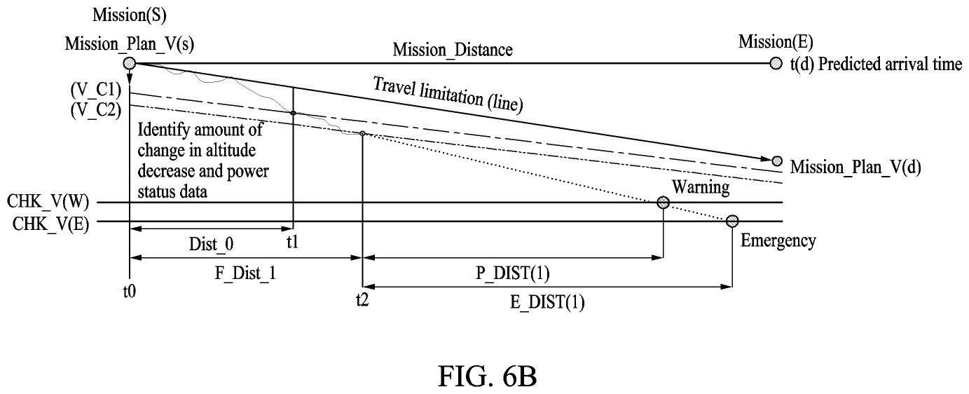

FIG. 6A is a diagram illustrating an operation in which an identification module 250 according to various embodiments identifies a failure due to a decrease in altitude, based on power status data of a UAV 100 flying between the waypoint of a departure point and the waypoint of a target point in a travel section other than take-off and landing sections. Referring to FIG. 6A, according to various embodiments, an identification module (e.g., the identification module 250 of FIG. 1B) may start identifying a failure due to a decrease in altitude based on status data of the UAV 100 and power status data when an altitude falls below a reference altitude (e.g., a first reference altitude and a second reference altitude) due to power shortage of the UAV 100 based on a mission.

According to various embodiments, the identification module 250 may identify a failure due to a decrease in altitude based on the power status data according to the current altitude of the UAV 100. When the current altitude R_{ATL}_{_{L(1)}}^{DF} of the UAV 100 is less than an altitude 600 P_{ATL}_{_{L(1)}}^{DF} according to a path for the mission and is greater than a first reference altitude 603 and a second reference altitude 604, the identification module 250 may identify, by [Equation 4] to [Equation 6], whether the UAV 100 reaches a failure identification altitude (E_D_ALT) against a travel plan due to an altitude decrease before completion of the mission, based on the power status data.

$$E 1 ( ALT / t ) = \frac{( {P}_{{ALT}_{L ( 1 )}^{DF}} - {R}_{{ALT}_{L ( 1 )}^{DF}} )}{( {t}_{1} - {t}_{o} - 1 )} ( {t}_{d} - {t}_{1} + 1 ) \qquad [ Equation 4 ]$$

$$rest\_E 1 ( t ) = ( {R\_ALT}_{L ( 0 )}^{DF} - E\_D \_ALT ) - ( {P}_{{ALT}_{L ( 1 )}^{DF}} - {R}_{{ALT}_{L ( 1 )}^{DF}} ) \qquad [ Equation 5 ]$$

$$after\_E 1 ( t ) = rest\_E 1 ( t ) - E 1 ( ALT / t ) - ( {P}_{{ALT}_{L ( 1 )}^{DF}} - {R}_{{ALT}_{L ( 1 )}^{DF}} ) . \qquad [ Equation 6 ]$$

Here, t_{d} may denote a timepoint of arriving at a travel section, t₁ may denote a time of the current position of a drone higher than the second reference altitude 604, E1(ALT/t) may denote a predicted altitude change by the flight altitude gradient values of a planned flight altitude and a current flight altitude, and after_E1(t) may denote a value for identifying arrival in a failure identification detection altitude 602 against the travel plan before the completion of a delivery mission. The identification module 250 may use after_E1(t) to thus generate and provide a result of predicting a time when the UAV 100 reaches a position corresponding to the first reference altitude 603.

For example, when after_E1(t) is greater than or equal to −1 and less than 0, the identification module 250 may identify the risk level of the failure as notice, when after_E1(t) is greater than or equal to −2 and less than −1, the identification module 250 may identify the risk level of the failure as warning, and when after_E1(t) is less than −2, the identification module 250 may identify the risk level of the failure as emergency.

According to various embodiments, the identification module 250 may generate a result of predicting a position (e.g., a position corresponding to the failure identification detection altitude 602) where a failure occurs due to an altitude decrease; a distance to the predicted position and a time taking thereto; and a value of a flight-available distance based on remaining power. Then, the identification module 250 may transmit, to the response module 260, a predicted amount of power consumption to perform mission reduction control based on mission data generated to reduce a mission; travel control to travel to a position available for emergency landing; and emergency landing control. The predicted amount of power consumption may be calculated by performing an operation described below with reference to FIG. 6B. The response module 260 may transmit, to the generation module 220, a control signal to reduce the mission based on the predicted position and may generate a control signal to reduce the mission and to control an emergency landing based on the predicted amount of power consumption.

FIG. 6B is a diagram illustrating an operation in which the identification module 250 identifies whether the UAV 100 may perform a mission during a failure due to a decrease in altitude, based on power status data of the UAV 100.

Referring to FIG. 6B, according to various embodiments, the identification module 250 may identify whether the UAV 100 may perform the mission, based on power status data of the UAV 100, during a failure due to a decrease in altitude. The identification module 250 may calculate a predicted amount of power consumption corresponding to the remaining flight distance of the UAV 100, based on the current position of the UAV 100. The estimated amount of power consumption corresponding to the remaining flight distance may be calculated as in [Equation 7].

E_V(1)=V_M(M_Dist(T)−F_Dist(1)) [Equation 7]

Here, E_V(1) may denote the estimated amount of power consumption corresponding to the remaining flight distance, V_M may denote a gradient value obtained by dividing the amount of consumption power to a current position by a travel distance to the current position, M_Dist(T) may denote a total travel distance for a mission, and F_Dist(1) may denote a travel distance to the current position.

According to various embodiments, the identification module 250 may identify whether the UAV 100 may perform the mission by comparing the predicted amount of power consumption corresponding to the remaining flight distance to the amount of power corresponding to the warning level and emergency level of a failure according to the power status data. The amount of power corresponding to the warning level and the emergency level of the failure according to the power status data may be calculated based on flight performance data of the UAV 100.

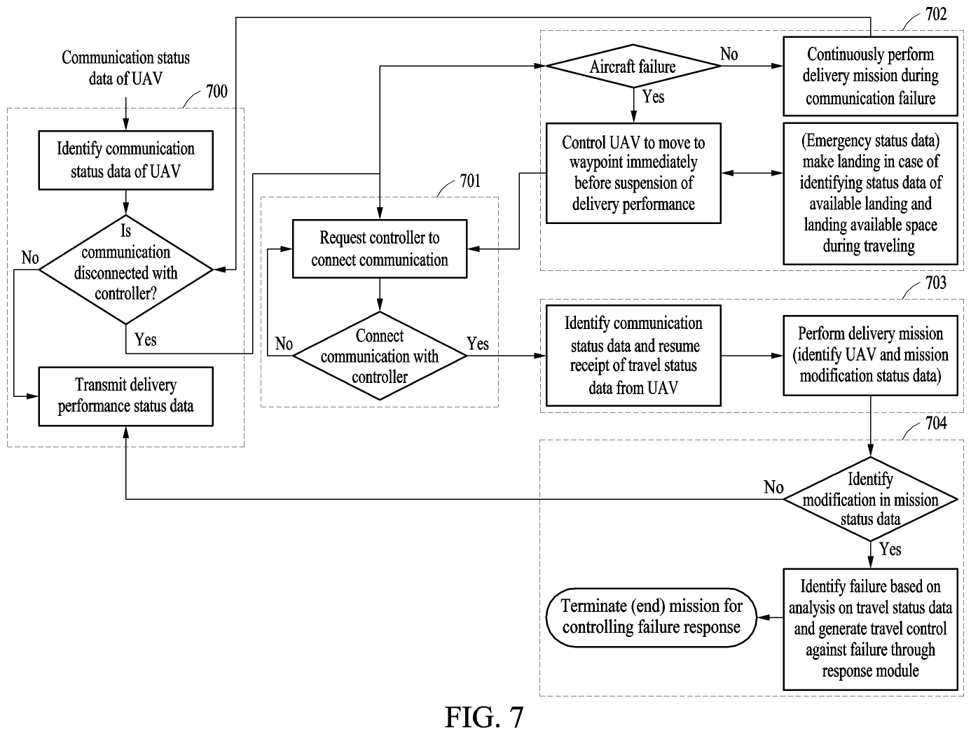

FIG. 7 is a flowchart illustrating an operation in which an aircraft management module identifies a communication failure of a UAV 100 on a mission.

Operations 700 to 704 may be operations in which an aircraft management module (e.g., the aircraft management module 130 of FIG. 1A) identifies whether communication between the UAV 100 and a communication management module (e.g., the communication management module 210 of FIG. 1B) is disconnected.

In operation 700, the aircraft management module 130 included in a UAV (e.g., the UAV 100 of FIG. 1A) on a mission may autonomously identify a communication failure (e.g., disconnection of communication between the UAV 100 and the communication management module 210), based on communication status data of the UAV 100. When the communication failure of the UAV 100 is not identified, the aircraft management module 130 may provide status data of the UAV 100 to a ground control system (e.g., the ground control system 200 of FIG. 1B).

In operation 701, when the communication failure of the UAV 100 is identified, the aircraft management module 130 may request the communication management module 210 to reconnect communication at a predetermined time interval. When the request for the communication reconnection is identified by the aircraft management module 130 of the ground control system 200 at a predetermined time interval, communication may be connected to a previously connected communication channel.

In operation 702, the UAV 100 may autonomously generate a flight control signal based on component operation status data of the UAV 100 when the communication connection is disconnected. For example, the aircraft management module 130 may identify a failure in a component of the UAV 100 according to the component operation status data of the UAV 100 and, when the failure does not exist, may determine to generate a flight control signal. A flight control module (e.g., the flight control module 140 of FIG. 1B) of the UAV 100 may continue to perform a mission when a component failure does not occur during communication disconnection. When the aircraft management module 130 determines that a failure exists in the component of the UAV 100, the aircraft management module 130 may determine to generate a flight control signal for moving the UAV 100 to a closer waypoint among a next waypoint and a waypoint before the communication failure occurs. The flight control module 140 may control the UAV 100 based on the flight control signal. The aircraft management module 130 may determine to generate a control signal corresponding to emergency landing control when the risk level of the failure in the component of the UAV 100 is emergency. The flight control module 140 may generate the control signal corresponding to the emergency landing control to determine an area available for the landing of the UAV 100 based on terrain status data obtained by the sensor of the UAV 100 and may cause the UAV 100 to make an emergency landing in the area available for the landing. The area available for the landing may be determined by comparing the size of the UAV 100, the gradient of the ground, and the size of a landing space.

In operation 703, when the UAV 100 on the mission is communicatively reconnected to the communication management module 210, the UAV 100 may transmit the mission device type of the UAV 100 (e.g., the model name of the UAV 100), travel conditions, existing flight performance data mapping to operation conditions, and component failure identification status, through the communication management module 210. The analysis module 240 may generate flight performance data modified by combining the existing flight performance data and current flight performance data.

In operation 704, the identification module 250 may identify a failure of the UAV 100 based on the flight performance data of the UAV 100 communicatively reconnected. When the identification module 250 identifies a failure of the UAV 100, the identification module 250 may generate a safety control procedure corresponding to the failure.

FIG. 8 is a diagram illustrating an operation in which an identification module according to various embodiments identifies a failure due to an occupancy time.

Referring to FIG. 8, according to various embodiments, when a generation module 220 is not able to determine an occupancy time of a UAV 100 at one or more target points, an identification module (e.g., the identification module 250 of FIG. 1B) may identify a failure due thereto. The identification module 250 may determine whether a time when a UAV other than the UAV 100 occupies one or more target points overlaps a time when the UAV 100 overlaps the one or more target points. When the overlapping time is less than ½ of a preset slack time interval, the identification module 250 may identify the risk level of a failure as warning, and when the overlapping time is greater than the preset slack time interval, the identification module 250 may identify the risk level of the failure as emergency.

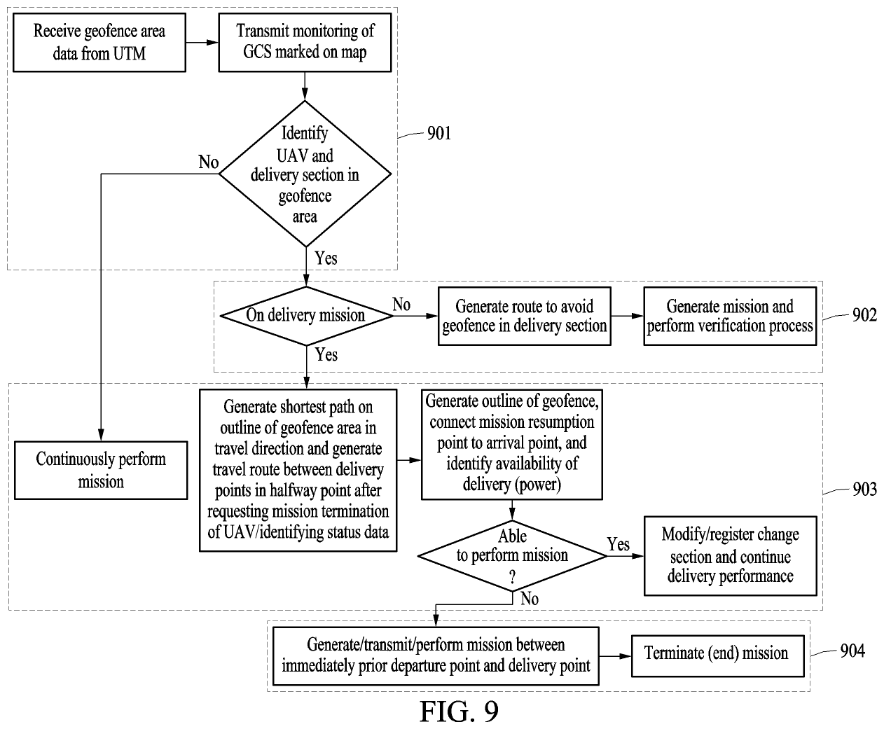

FIG. 9 is a flowchart illustrating an operation in which a ground control system according to various embodiments performs safety control of a UAV according to a mission performance operation when the ground control system identifies geofence information from a UTM system.

In operations 901 to 904, an identification module (e.g., the identification module 250 of FIG. 1B) included in a ground control system 200 may generate a safety control procedure corresponding to geofence information and a response module (e.g., the response module 260 of FIG. 1B) may generate a control signal corresponding to the safety control procedure, thereby controlling the UAV 100.

In operation 901, the identification module 250 may receive geofence information (e.g., a geofence area and a potential risk factor in the geofence area, such as a forest fire) from a UTM system (e.g., the UTM system 300 of FIG. 1B). The identification module 250 may identify a failure according to the geofence information by determining whether the path of the UAV 100 exists in the geofence area, based on the geofence information.

In operation 902, when the UAV 100 performs a first operation (e.g., a delivery preparation operation), the identification module 250 may generate a safety control procedure corresponding thereto. The safety control procedure in response to the failure according to the geofence information may include a procedure of generating a mission modification message requesting the generation module 220 to modify a mission plan, so that the path bypasses the geofence area.

In operation 903, when the UAV 100 performs a third operation (e.g., a travel operation), the identification module 250 may generate a safety control procedure corresponding to the third operation. The safety control procedure may include a procedure for performing temporary mission suspension control and mission modification control based on the geofence information. The mission modification control may include transmitting each of modified missions generated by the generation module 220 to the UAV 100 according to the control signal of the response module 260 and terminating the mission of the UAV 100 after checking that the UAV 100 has performed the modified missions and has landed. The modified missions may be missions modified for the UAV 100 to deviate from the geofence area in the vicinity of the outline of the geofence area through a shortest path. When the identification module 250 identifies that the UAV 100 may perform the modified missions, the response module 260 may control the UAV 100 to perform the modified missions.

In operation 904, when the identification module 250 identifies that the UAV 100 may not perform the modified missions, the identification module 250 may generate a safety control procedure according to mission reduction control and the response module 260 may generate a control signal corresponding the safety control procedure. The mission reduction control may include transmitting, to the UAV 100, a reduced mission generated by the generation module 220 according to the control signal of the response module 260 and terminating the mission of the UAV 100 after checking that the UAV 100 has performed the reduced mission and then has landed.

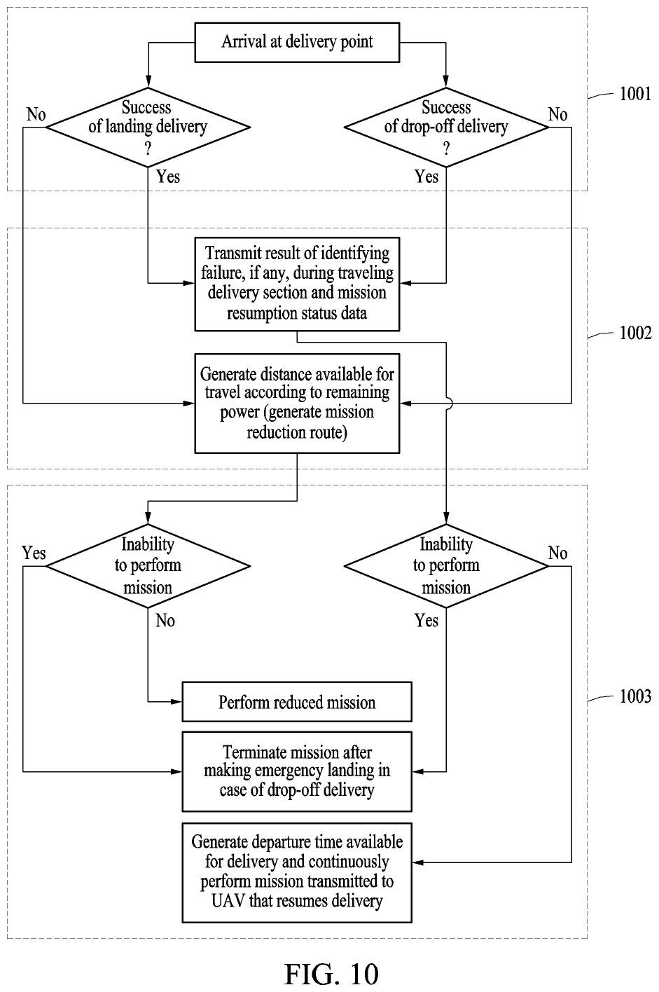

FIG. 10 is a flowchart illustrating an operation in which a ground control system according to various embodiments determines whether to continue to perform a mission according to a result of identifying a failure due to a delivery failure of a UAV 100 arriving at any one of a plurality of target points included in the mission.

Operations 1001 to 1003 may illustrate operations in which a ground control system (e.g., the ground control system 200 of FIG. 1B) according to various embodiments determines whether a UAV (e.g., the UAV 100 of FIG. 1B) arriving at any one of a plurality of target points continues to perform a mission. The mission of the UAV 100 may include a plurality of detailed missions, and the detailed mission may include delivering goods to any one of the plurality of target points included in the mission.

In operation 1001, the ground control system 200 may determine whether the UAV 100 has successfully performed a detailed mission, through drop-off or landing, for any one of the plurality of target points included in a mission (e.g., a product delivery mission). For example, the ground control system 200 may receive a signal according to the success of a mission (e.g., a detailed mission) of the UAV 100 from a loading box receiving goods corresponding to the detailed mission.

In operation 1002, when the UAV 100 succeeds in performing the detailed mission, the ground control system 200 may receive, from the UAV 100, data on whether a failure is identified during the performance of the detailed mission. When the UAV 100 succeeds in performing the detailed mission, the identification module 250 may identify a failure during mission performance according to the type of the mission and may generate a safety control procedure in response to the failure. The safety control procedure may include a procedure for sequentially performing temporary mission suspension control, mission reduction control, and emergency landing control when the mission is a drop-off delivery and may include a procedure for sequentially performing mission reduction control and mission termination when the mission is a landing delivery.

In operation 1003, when the UAV 100 is able to perform a reduction mission according to the mission reduction control included in the safety control procedure, the UAV 100 may perform the reduction mission. When the UAV 100 is not able to perform the reduction mission or when the UAV 100 has successfully completed a detailed mission but is not able to perform a next detailed mission, the UAV 100 may control termination of a mission upon an emergency landing in the case of a drop-off delivery and may terminate the mission in the case of a landing delivery. When the UAV 100 succeeds in performing the detailed mission and is able to perform the next detailed mission, the UAV 100 may perform the operation, described with reference to FIG. 4, for a remaining target point among one or more target points at a current time to thus determine a possible departure time and an occupancy time and may continuously perform the mission.

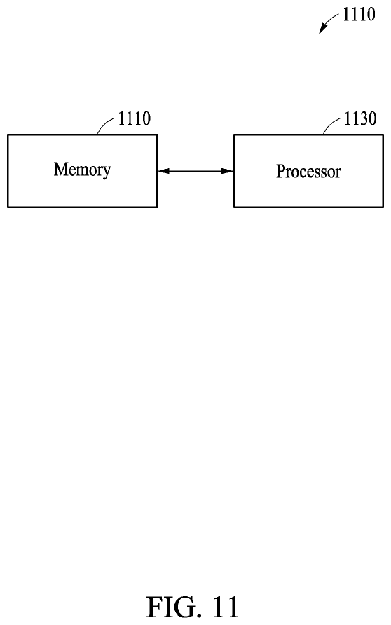

FIG. 11 is another example of a ground control system according to various embodiments.

Referring to FIG. 11, a ground control system 1100 may include a memory 1110 and a processor 1130.

The memory 1110 may store instructions (e.g., a program) executable by the processor 1130. For example, the instructions may include instructions for performing an operation of the processor 1130 and/or an operation of each component of the processor 1130.

According to one embodiment, the memory 1110 may be implemented as a volatile memory device or a non-volatile memory device. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The processor 1130 may execute computer-readable code (e.g., software) stored in the memory 1110 and instructions triggered by the processor 1130. The processor 1130 may be a hardware-implemented data processing device having a circuit that is physically structured to execute desired operations. The desired operations may include code or instructions included in a program. For example, the hardware-implemented data processing device may include a microprocessor, a CPU, a processor core, a multi-core processor, a multiprocessor, an application-specific integrated circuit (ASIC), and a field-programmable gate array (FPGA). According to various embodiments, operations performed by the processor 1130 may be substantially the same as the operations performed by the ground control system 200 described with reference to FIGS. 1 through 10. Each component of the ground control system 200 described in FIGS. 1 to 10 (e.g., the communication management module 210, the generation module 220, the analysis module 240, the database 245, the identification module 250, the response module 260, and second mission management module 270) may be executed by processor 1130. Accordingly, further description thereof is not repeated herein.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion.

The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of controlling safety, the method comprising:
identifying a failure of an Unmanned Aerial Vehicle (UAV) for each of a plurality of mission performance operations of the UAV, based on status data of the UAV received in real time from the UAV and past flight performance data of a case where the UAV normally performs a mission; and
controlling safety of the UAV based on the failure for each of the plurality of mission performance operations and a risk level of the failure,
wherein the status data comprises component operation status data of the UAV, power status data of the UAV, and communication connection status data of the UAV.

2. The method of claim 1, wherein the plurality of mission performance operations comprises a mission preparation operation, a take-off operation, a travel operation, and a delivery operation.

3. The method of claim 2, wherein the identifying comprises:
identifying the failure in the mission preparation operation; and
generating a mission of the UAV based on a result of the identifying in the mission preparation operation.

4. The method of claim 2, wherein
the identifying comprises identifying a failure based on the power status data, and
the controlling of the safety comprises:
in the mission preparation operation, controlling the safety, so that performance of a mission is not initiated in response to the failure based on the power status data; and
in the travel operation, sequentially performing temporary mission suspension control, mission reduction control, and emergency landing control in response to the failure based on the power status data,
wherein the mission reduction control comprises control for generating a reduced mission by reducing a travel distance of the UAV based on a path of a mission and a value of a possible flight distance according to the power status data of the UAV.

5. The method of claim 2, wherein
the identifying comprises identifying a failure according to the communication connection status data, and
the controlling of the safety comprises, in the travel operation, continuously making a request for communication reconnection to the UAV configured to autonomously control the safety according to a result of identifying the failure according to the component operation status data.

6. The method of claim 5, wherein the UAV configured to autonomously control the safety:
when there is no failure according to the component operation status data, continues to perform a mission even when there is the failure according to the communication connection status data; and
when there is the failure according to the component operation status data, autonomously controls the safety according to a risk level of the failure according to the component operation status data.

7. The method of claim 2, wherein
the identifying comprises identifying a failure due to deviation of a position of the UAV and deviation of an altitude of the UAV, and
the controlling of the safety comprises:
in the take-off operation, sequentially performing temporary mission suspension control, position return control, mission reduction control, and emergency landing control in response to the failure due to the deviation of the position of the UAV and the deviation of the altitude of the UAV; and
in the travel operation, when a risk level of the failure due to the deviation of the position of the UAV and the deviation of the altitude of the UAV is warning, performing the mission reduction control and, when the risk level of the failure due to the deviation of the position of the UAV and the deviation of the altitude of the UAV is emergency, sequentially performing the temporary mission suspension control, the position return control, the mission reduction control, and the emergency landing control,
wherein
the mission reduction control comprises control for generating a reduced mission by reducing a travel distance of the UAV based on a path of a mission and a value of a possible flight distance according to the power status data of the UAV, and
the position return control comprises control for moving the UAV to a next waypoint among a plurality of waypoints in the path of the mission when the UAV deviates from the position and control for moving the UAV up and down by as much as a deviated altitude when the UAV deviates from the altitude.

8. The method of claim 7, wherein the identifying of the failure due to the deviation of the position of the UAV and the deviation of the altitude of the UAV comprises
determining, to be any one of the warning and the emergency, a risk level of the failure due to the deviation of the position of the UAV and the deviation of the altitude of the UAV, according to whether the UAV deviates from an angle, a distance, and the altitude, by comparing the path of the mission and a current position of the UAV comprised in the status data.

9. The method of claim 2, wherein
the identifying comprises identifying a failure according to a final rejection of Unmanned Aircraft System (UAS) traffic management (UTM) or geofence information, and
the controlling of the safety comprises:
in the mission preparation operation, controlling the safety, so that performance of a mission is not initiated in response to the final rejection and performing mission modification control in response to the failure according to the geofence information; and
in the travel operation, performing temporary mission suspension control in response to the failure according to the geofence information and the mission modification control based on the geofence information,
wherein
the mission modification control comprises control for reaching a target point in a path of the mission by deviating from an area corresponding to the geofence information by a shortest distance, along an outline of the area.

10. The method of claim 2, wherein
the identifying comprises identifying a failure due to a failure of a mission, and
the controlling of the safety comprises, in the delivery operation, sequentially performing temporary mission suspension control, mission reduction control, and emergency landing control when the mission is a drop-off delivery and sequentially performing the mission reduction control and mission termination when the mission is a landing delivery.

11. The method of claim 3, further comprising:
in the mission preparation operation, comparing a sum of a departure preparation time, a take-off time, and an arrival interval maintenance time of the UAV to a time interval between a time when another UAV besides the UAV releases occupancy of a departure point comprised in the mission and a time when the UAV initiates the occupancy of the departure point; and
determining a departure time of the UAV based on whether occupancy times between the UAV and the other UAV overlap.

12. The method of claim 1, wherein a communication channel with the UAV comprises:
a normal port configured to transmit and receive a mission and status data; and
an urgent port configured to receive, from the UAV, a result in which the UAV autonomously identifies a failure and transmit, to the UAV, a control signal corresponding to the controlling of the safety.

13. A ground control system comprising:
a memory comprising instructions; and
a processor electrically connected to the memory and configured to execute the instructions,
wherein, when the instructions are executed by the processor, the processor is configured to:
identify a failure of an Unmanned Aerial Vehicle (UAV) for each of a plurality of mission performance operations of the UAV, based on status data of the UAV received in real time from the UAV and past flight performance data of a case where the UAV normally performs a mission; and
control safety of the UAV based on the failure for each of the plurality of mission performance operations and a risk level of the failure, and
wherein the status data comprises component operation status data of the UAV, power status data of the UAV, and communication connection status data of the UAV.

14. The ground control system of claim 13, wherein the plurality of mission performance operations comprises a mission preparation operation, a take-off operation, a travel operation, and a delivery operation.

15. The ground control system of claim 14, wherein the processor is configured to:
identify the failure in the mission preparation operation; and
generate a mission of the UAV based on a result of the identifying in the mission preparation operation.

16. The ground control system of claim 14, wherein
the processor is configured to:
identify a failure based on the power status data;
in the mission preparation operation, control the safety, so that performance of a mission is not initiated in response to the failure based on the power status data; and
in the travel operation, sequentially perform temporary mission suspension control, mission reduction control, and emergency landing control in response to the failure based on the power status data,
wherein the mission reduction control comprises control for generating a reduced mission by reducing a travel distance of the UAV based on a path of a mission and a value of a possible flight distance according to the power status data of the UAV.

17. The ground control system of claim 14, wherein the processor is configured to:
identify a failure according to the communication connection status data; and
in the travel operation, continuously make a request for communication reconnection to the UAV configured to autonomously control the safety according to a result of identifying the failure according to the component operation status data.

18. The ground control system of claim 17, wherein the UAV configured to autonomously control the safety:
when there is no failure according to the component operation status data, continues to perform a mission even when there is the failure according to the communication connection status data; and
when there is the failure according to the component operation status data, autonomously controls the safety according to a risk level of the failure according to the component operation status data.

19. The ground control system of claim 14, wherein
the processor is configured to:
identify a failure due to deviation of a position of the UAV and deviation of an altitude of the UAV,
in the take-off operation, sequentially perform temporary mission suspension control, position return control, mission reduction control, and emergency landing control in response to the failure due to the deviation of the position of the UAV and the deviation of the altitude of the UAV; and
in the travel operation, when a risk level of the failure due to the deviation of the position of the UAV and the deviation of the altitude of the UAV is warning, perform the mission reduction control and, when the risk level of the failure due to the deviation of the position of the UAV and the deviation of the altitude of the UAV is emergency, sequentially perform the temporary mission suspension control, the position return control, the mission reduction control, and the emergency landing control,
wherein the mission reduction control comprises control for generating a reduced mission by reducing a travel distance of the UAV based on a path of a mission and a value of a possible flight distance according to the power status data of the UAV, and
the position return control comprises control for moving the UAV to a next waypoint among a plurality of waypoints in the path of the mission when the UAV deviates from the position and control for moving the UAV up and down by as much as a deviated altitude when the UAV deviates from the altitude.

20. A system comprising:
an unmanned aerial vehicle (UAV); and
a ground control system configured to be communicatively connected to the UAV and an Unmanned Aircraft System (UAS) traffic management (UTM) system,
wherein the ground control system comprises:
a memory comprising instructions; and
a processor electrically connected to the memory and configured to execute the instructions,
wherein, when the instructions are executed by the processor, the processor is configured to:
identify a failure of the UAV for each of a plurality of mission performance operations of the UAV, based on status data of the UAV received in real time from the UAV and past flight performance data of a case where the UAV normally performs a mission; and
control safety of the UAV based on the failure for each of the plurality of mission performance operations and a risk level of the failure,
wherein the status data comprises component operation status data of the UAV, power status data of the UAV, and communication connection status data of the UAV.
